(19) United States
(12) Patent Application Publication
(10) Pub. No.: US 2010/0275666 A1
(43) Pub. Date: Nov. 4, 2010

(54) Silicon-Containing Mixture

(76) Inventor: Vladimir V. Matichenkov, Doral, FL (US)

Correspondence Address: NOTARO, MICHALOS & ZACCARIA P.C., 100 DUTCH HILL ROAD, ORANGEBURG, NY, 10962, US

(21) Appl. No.: 12/432,237

(22) Filed: Apr. 29, 2009

(51) Int. Cl. C05D 9/00

(52) U.S. Cl. 71/62

(57) ABSTRACT

A compound which includes a mixture of three components; wherein a first component a is liquid silicon-rich solution (Part A); a second component is a solid matrix (Part B); wherein Part A and Part B are mixed together and dried; and a third component (Part C) for optimizing the properties of the mixture of Part A and Part B. Embodiments of the present invention provide a silicon fertilizer having both the active monosilicic acid content of silicon found in liquid silicon fertilizers and the prolonged effect in the soil-plant system of solid silicon fertilizers.

### FIELD OF THE INVENTION

The present invention relates to silicon compounds and their use in agriculture, environmental protection, detoxification of toxic substances and other applications which employ silicon.

### BACKGROUND OF THE INVENTION

The necessity of using silicon fertilizers and silicon-rich biostimulators for high-yield crop production and for restoration of polluted or degraded areas of soil and water is well known (Ma and Takahashi, 2002; Snyder et al., 2001). Today numerous forms of silicon fertilizers and soil amendments are available. There are natural silicon fertilizers such as diatomite, perlites, silicon-rich slags (which are used as silicon fertilizers), and liquid silicon fertilizers (Snyder et al., 2001). Solid silicon fertilizers have a long effect on the soil-plant system, but they have less monosilicic acid, the active part of silicon fertilizers and silicon soil amendments (Matichenkov et al., 2001). Liquid silicon fertilizers have more active content of silicon as monosilicic acid, but they do not provide a very prolonged effect in the soil-plant system.

The key to a more perfect silicon fertilizer or silicon-rich soil amendment is in substances whose properties are a combination of solid and liquid forms of silicon fertilizers: high content of active silicon (monosilicic acid) and long term, prolonged effects.

Some technologies for increasing the efficiency of traditional fertilizers by mixing with synthetic silicates are known. See U.S. Pat. No. 3,266,886 to B. Middleton et. al. Russian Patent Serial No. 2122903 to Matichenkov et al. describes mixing of various forms of silicon-rich materials. These patents only outline mixing without providing additional procedural steps. The result of this mixing increases the efficiency of silicon-rich products, but does not provide any of the combined properties of liquid and solid forms of silicon fertilizers.

The surface chemistry of solid silicon-rich compounds depends on numerous factors, including, chemical composition, surface area and surface structure (Iler, 1979). The solubility of silicon-rich substances depends on surface area and amount of hydroxyl groups available on the surface itself. The higher the area and the greater the hydroxyl group content, the better the solubility of silicon-rich materials and more available monosilicic acid for the solution (Iler, 1979).

The adsorption of monosilicic acid on the surface of the solid particles, and the drying process which follows, generates the formation of a high amount of polysilicic acids. The gradual drying of the adsorbed monosilicic and/or polysilicic acids results in a dehydration process (Matichenkov et al., 1995). If the dehydration process continues until all hydro-groups are completely removed from the solid surface, hard crystals, like quartz are formed (Iler, 1979). As a result the adsorbed mono- and poly-silicic acids loose their mobility.

Thus, a silicon fertilizer having the combined properties of liquid and solid forms of silicon fertilizers is needed.

The present invention satisfies this and other needs and overcomes deficiencies found in the prior art.

### SUMMARY OF THE INVENTION

Accordingly, it is an object of the present invention to provide a silicon fertilizer having both the active monosilicic acid content of silicon found in liquid silicon fertilizers and the prolonged effect in the soil-plant system of solid silicon fertilizers.

These and other objects of the present invention are achieved in accordance with one embodiment of the present invention by provision of a compound which includes a mixture of three components; wherein a first component a is liquid silicon-rich solution (Part A); a second component is a solid matrix (Part B); wherein Part A and Part B are mixed together and dried; and a third component (Part C) for optimizing the properties of the mixture of Part A and Part B.

Embodiments of the present invention provide a novel product for delivering active silicon (monosilicic acid) and a method for producing the same. The product is produced by mixing liquid silicon-rich materials with a solid matrix, followed by soft drying. Monosilicic and/or polysilicic acid are adsorbed by the surface of the matrix, after which drying is conducted. However the drying process is not carried to completion and dehydration is not complete. As a result the new product possess unique properties: adsorbed monosilicic and/or polysilicic acids with a high hydroxyl group content.

The high hydroxyl group content in adsorbed monosilicic and polysilicic acids provides high solubility to the novel material and thus the best delivery of active silicon to soil, ground, water, plant, animals, microorganisms or other media or living organisms. The final product can be used in any context in which it is necessary to add active silicon to soil (e.g., to increase the content of active silicon, to increase soil fertility level of active soil microorganisms, or to effect other soil properties), water (to increase monosilicic acids content), living organisms (to provide plant silicon nutrition), and artificial apparatuses (filters, vessels, or other equipment).

### DESCRIPTION OF THE PREFERRED EMBODIMENTS

The present invention satisfies needs left unresolved by the prior art by providing a silicon fertilizer having both the active monosilicic acid content of silicon found in liquid silicon fertilizers and the prolonged effect in the soil-plant system of solid silicon fertilizers.

Embodiments of the present invention provide a new product for delivering active silicon (monosilicic acid) to a solid matrix (soil, ground, rocks), water media (natural or industrial waters), living organisms, and artificial apparatuses (technical equipment and devices) and consists of two main parts (Part A and Part B) as well as additional substances (Part C).

Part A is a silicon-rich liquid form. Part A may contain one or more silicon-rich liquid or soil substances, which can provide active silicon (monosilicic acid) and provide in water or organic solution the concentration of monosilicic acid from about 10 mg Si/L to about 500,000 mg Si/L.

Part B may contain one or more solid substances playing the role of a matrix, to which Part A may be adsorbed and then delivered to a desired target for which it is necessary to increase the content of active silicon.

The additional substances (Part C) of this formula for a novel product may be added for several reasons: increasing the stability of the activators, optimizing the physical properties of the mixture of Part A and Part B, and as materials to improve the effect of the novel product.

Part A, Part B and Part C may be mixed together and then to dried at temperatures from about −20° C. to about 500° C. during a time period from about one second to about ten years. The ratio between Part A and Part B can range from about 1:100,000 to 1,000,000:1.

The novel product according to embodiments of the present invention may be applied to a solid matrix (soil, ground, rock et al.), water (natural or industrial), living organisms or artificial apparatuses or devices at rates from about 0.0000001 % to about 99.99999%.

Next, the present invention will be described in further detail by means of examples, without intending to limit the scope of the present invention to these examples alone. The following are exemplary methods for producing a novel product in accordance with the present invention.

### EXAMPLE 1

As Part A, ZumSil (commercial liquid silicon-rich materials, produced by Terra Tech Corp, Miami, Fla.) was used. As Part B, calcium silicate and diatomite earth from Columbia, were used.

Both Part B materials were mixed with ZumSil in a proportion of A:B of 10:20 and dried at 24° C. for one day. The final products had only solid parts. Two grams of final products and the original Part B substances were added to 100 ml glass flasks and 50 ml of distilled water was added to each flask. After that, the mixtures with water were shaken for one hour and then filtrated. The content of monosilicic acid in supernatant was determined.

The results are presented in Table 1. The results show that modification of both original solid substances results in an increase of active silicon content one the order of 1000 to 2000 times more.

TABLE 1
Content of monosilicic acid in water extraction according to
embodiments of the present invention

| | | Content of |
|---|---|---|
| | Size of | monosilicic acid, |
| Material | particles(mm) | (mg Si/kg) |
| Calcium silicate | 0, 1-4 | 18-22 |
| Modified Calcium | 3-5 | 18000-23000 |
| silicate (New | | |
| product) | | |
| Diatomite | <0, 2 | 10-12 |
| Modified diatomite | 2-5 | 20000-25000 |

### EXAMPLE 2

The experiment was conducted in greenhouse using silt soil, which is classified as an Alfisol. Potassium silicate, a commercial liquid silicon-rich material, which contains 12% silicon as monosilicic acid, diluted 100 times, was used as Part A. For Part B the following substances were used: (1) Slag from the metal industry; (2) crushed basalt; and (3) dry soil calcium silicate and diatomite from Columbia.

All Part B materials were mixed with potassium silicate in a proportion of A:B of 20:100 and dried at 65° C. for one day. The final products had only solid parts.

The final products were added to the Alfisol in one-liter plastic pots at a rate of 1 g per kg, by incorporation. Barley (Hordeum vulgare L.) seeds were added to the treated and control pots (20 seeds per pot). Barley was grown for three weeks and then the barley biomass, the content of silicon in the plants and the content of monosilicic acid in the soil were determined. Four replications were conducted for each treatment.

The results are present in Table 2. The results show that a substance such as “soil” does not have an effect on the tested parameters. Potassium silicate had little effect on the tested parameters. Maximum effects were obtained with the modified products.

TABLE 2
Effect of modified and non modified solid substances on barley
biomass, according to the content of silicon in plants and content
of monosilicic acid in the soil

| | Weight of 10 | Total Si content | Monosilicic acid |
|---|---|---|---|
| Treatment | fresh plants (g) | of plants (% Si) | in soil (mg/kg Si) |
| Control | 0.73 | 0.50 | 4.7 |
| Slag | 0.85 | 0.82 | 8.5 |
| Basalt | 0.88 | 0.88 | 8.8 |
| Soil | 0.73 | 0.50 | 4.7 |
| Potassium silicate | 0.78 | 0.67 | 4.9 |
| Modified Slag | 1.12 | 1.28 | 20.9 |
| Modified Basalt | 1.25 | 1.32 | 25.7 |
| Modified Soil | 1.17 | 1.26 | 28.3 |
| STD₀₅ | 0.10 | 0.10 | 1.15 |

### EXAMPLE 3

For Part A, sodium silicate, a commercial liquid silicon-rich material containing 10% silicon as monosilicic acid, diluted 50 times was used. For Part B, the following substances were used (1) Slag from the metal industry; (2) crushed basalt; and (3) dry soil (Gray Forest soil from the southern part of the Moscow region) were used.

The Part B materials (100 g) were mixed with 20 ml of diluted sodium silicate and dried at 64° C. for one day. The final products had only solid parts. Four grams of the final product were mixed with 1 kg of surface horizon of Gray Forest soil. The mixtures and Part B substances were placed into a plastic column having a diameter 10 cm and length of 20 cm. The solution of sodium silicate was used as the control and was also placed into a column together with upper horizon Gray Forest soil, but without drying. The amount of applied sodium silicate (10% silicon) was the same as the amount applied to the mixture of Part B substances with Part A. The experiment was replicated four times.

To each column was added 100 ml of solution containing 250 mg of Cd as CdCl₂; 200 mg Cu as CuSO₄; 100 mg Ni as NiSO₂ and 150 mg Pb as Pb(NO₃)₂. An additional amount of 200 ml of distilled water was added to each column and the percolated solutions were collected every day during one week. The content of Cd, Cu, Ni and Pb in the percolated solutions was determined and measured by the atomic-adsorption method and the concentration of monosilicic acid was measured by molybdenum-ammonium method (Iler, 1979). The soils from the columns were dried and tested for their content of Cd, Cu, Ni and Pb in MgCl₂ and the standard extraction method with 0.1 N HCl was used to determine the mobile and potential mobile forms of Cd, Cu, Ni and Pb.

Table 3 shows the dynamic of the Si, Cd, Cu, Ni and Pb content in the percolated solutions. The application of silicon-rich substances increased the content of monosilicic acid in the percolated solutions. The best test results were obtained with the last three products presented in Table 3. The heavy metal content in the percolated solution was reduced considerably with the application of treated slag, basalt and soil treated with sodium silicate.

TABLE 3
Table summarizing the dynamic of Si, Cd, Cu, Ni and Pb content in the
percolated solutions(mg/L)

| | Si | | Cd | | Cu | | Ni | | Pb | |
|---|---|---|---|---|---|---|---|---|---|---|
| | Start | Finish | Start | Finish | Start | Finish | Start | Finish | Start | Finish |
| Control | 12.6 | 10.3 | 8.6 | 1.2 | 14.2 | 2.3 | 3.8 | 1.1 | 2.45 | 0.51 |
| Slag | 23.6 | 15.5 | 4.5 | 1.1 | 5.4 | 1.1 | 2.5 | 0.5 | 1.67 | 0.34 |
| Basalt | 22.8 | 18.4 | 3.2 | 0.5 | 6.3 | 1.2 | 2.3 | 0.4 | 1.45 | 0.24 |
| Soil | 12.5 | 10.4 | 8.6 | 1.2 | 14.4 | 2.2 | 3.7 | 1.0 | 2.46 | 0.50 |
| Sodium | 156.7 | 35.9 | 2.8 | 0.6 | 2.4 | 0.5 | 2.1 | 0.2 | 0.43 | 0.12 |
| silicate | | | | | | | | | | |
| Mixing | 57.8 | 55.9 | 1.4 | 0.2 | 1.2 | 0.2 | 1.4 | 0.1 | 0.34 | 0.16 |
| with | | | | | | | | | | |
| Slag | | | | | | | | | | |
| Mixing | 88.5 | 74.3 | 1.2 | 0.3 | 3.2 | 0.2 | 1.7 | 0.1 | 0.45 | 0.11 |
| with | | | | | | | | | | |
| Basalt | | | | | | | | | | |
| Mixing | 95.3 | 88.4 | 0.6 | 0.3 | 1.7 | 0.4 | 1.2 | 0.2 | 0.37 | 0.06 |
| with Soil | | | | | | | | | | |
| STD₀₅ | 1.5 | 2.5 | 1.5 | 0.6 | 1.5 | 0.5 | 0.5 | 0.4 | 0.5 | 0.2 |

The content of the tested elements, with extractions from soil, are presented in Table 4. All treated materials (excluding non-treated soil applications) exhibited a significant increase in the content of water soluble silicon and a significant decrease in the heavy metals in magnesium chlorine and hydrochloric acid extractions from soil samples. The applied mixtures of Part B and Part A exhibited the best effect.

TABLE 4
Content of Si, Cd, Ni, Cu and Pb extractions from soil after experiments
mg/kg

| | | Cd | | Cu | | Ni | | Pb | |
|---|---|---|---|---|---|---|---|---|---|
| | Si | MgCl₂ | HCl | MgCl₂ | HCl | MgCl₂ | HCl | MgCl₂ | HCl |
| Control | 4.8 | 0.65 | 6.5 | 2.3 | 20.4 | 0.45 | 5.3 | 0.23 | 2.3 |
| Slag | 8.8 | 0.34 | 2.4 | 1.3 | 11.4 | 0.23 | 4.1 | 0.12 | 1.4 |
| Basalt | 9.6 | 0.42 | 2.3 | 1.7 | 12.7 | 0.27 | 3.6 | 0.14 | 1.3 |
| Soil | 4.7 | 0.64 | 6.7 | 2.3 | 20.5 | 0.46 | 5.2 | 0.23 | 2.2 |
| Sodium | 4.9 | 0.28 | 1.7 | 1.2 | 9.6 | 0.16 | 2.6 | 0.11 | 1.1 |
| silicate | | | | | | | | | |
| Mixing with | 19.7 | 0.12 | 1.2 | 0.5 | 9.2 | 0.11 | 2.1 | 0.04 | 0.6 |
| Slag | | | | | | | | | |
| Mixing with | 26.8 | 0.12 | 0.4 | 0.4 | 7.4 | 0.07 | 1.8 | 0.05 | 0.7 |
| Basalt | | | | | | | | | |
| Mixing with | 27.9 | 0.07 | 0.5 | 0.4 | 6.3 | 0.08 | 1.9 | 0.03 | 0.2 |
| Soil | | | | | | | | | |
| STD₀₅ | 0.6 | 0.21 | 0.3 | 0.2 | 1.5 | 0.07 | 0.6 | 0.02 | 0.4 |

### EXAMPLE 4

As Part A, a mixture of potassium silicate (commercial liquid silicon-rich material, which contains 12% silicon as monosilicic acid) with commercial Humate (Borregrow, Spain) in a proportion of 10:1 was used. It was diluted 20 times. For Part B, the following were used: (1) Slag from the metal industry; and (2) amorphous silicon dioxide with a surface area 30 M²/g. One kilogram of solid substances (1) and (2) was mixed with 100 ml of potassium silicate+Humate solution and dried for one hour at 65° C. The experiment was conducted in plastic pots having a volume of one liter. Alluvial sandy soil (from the southern part of the Moscow region and Oka river soil from the water-meadow area) polluted by hydrocarbons (a mixture of used motor oil and diesel in a ratio of 1:1) was used. The level of artificial pollution was 3% hydrocarbons of the total soil mass.

The final solid silicon-rich substances were mixed with the polluted soil at the rate of 5 g per 1 kg of soil together with 0.5 ml of potassium silicate+Humate solution. Next, barley (Hordeum vulgare L.) seeds were added to each pot (10 seeds per pot) and were grown for four weeks. Then, the biomass of barley and the content of hydrocarbons was measured. Four replications of each of the treatments were conducted.

The results of this experiment are presented in Table 5. The application of silicon-rich substances had positive influence on barley and at the same time reduced the content of hydrocarbons in the polluted soil. However, the effect of solid silicon-rich materials, mixed with a liquid solution of potassium silicate+Humate, produced better results than any other solid original materials.

TABLE 5
Effect of Si-rich substances on barley and content
of hydrocarbons in soil

| | | Content of |
|---|---|---|
| Treatments | Weight of 10 dry plants, g | hydrocarbons, % |
| Control | 0.27 | 2.45 |
| Slag | 1.78 | 1.17 |
| Amorphous SiO₂ | 2.15 | 1.23 |
| Potassium silicate | 0.35 | 2.40 |
| solution + Humate | | |
| Mixture Slag and | 2.78 | 0.78 |
| potassium | | |
| silicate + Humates | | |
| Mixture Amorphous | 2.97 | 0.94 |
| SiO₂and potassium | | |
| silicate + Humates | | |
| STD₀₅ | 0.42 | 0.21 |

While specific embodiments of the invention have been shown and described in detail to illustrate the application of the principles of the invention, it will be understood that the invention may be embodied otherwise without departing from such principles.

What is claimed is:

1. A compound comprising a mixture of three components wherein a first component a is liquid silicon-rich solution (Part A); a second component is a solid matrix (Part B); wherein Part A and Part B are mixed together and dried; and a third component (Part C) for optimizing the properties of the mixture of Part A and Part B.

2. The compound according to claim 1, wherein said drying is performed at temperatures between about −20° C. and about 500° C.

3. The compound according to claim 1, wherein said drying is performed during a period ranging from about one second in length to about ten years in length.

4. The compound according to claim 1, wherein Part A has a silicon concentration which falls in the range from about 10 mg Si/L to about 500,000 mg Si/L.

5. The compound according to claim 1, wherein Part A is a solution selected from the group consisting of aqueous solution and organic solution.

6. The compound according to claim 5, wherein said solution has a pH which falls in the range of about 1 to about 14.

7. The compound according to claim 5, wherein said solution is a mixture of two or more Si-rich solutions.

8. The compound according to claim 1, wherein Part B is a solid substance selected from the group consisting of particle, fiber, metal, mineral and waste.

9. The compound according to claim 8, wherein said solid substance is a mixture of two or more solid substances.

10.The compound according to claim 8, wherein said substance is organic.

11. The compound according to claim 8, wherein said substance is inorganic.

12. The compound according to claim 1, wherein a ratio between Part A and Part B is in the range from about 1:100,000 to about 1,000,000:1.

13. The compound according to claim 1, wherein Part A and Part B are used without Part C.

14. The compound according to claim 1, wherein Part C is an inorganic substance.

15. The compound according to claim 1, wherein Part C is an organic substance.

16. The compound according to claim 1, wherein Part C is a mixture of more than one liquid substance.

17. The compound according to claim 1, wherein Part C is a mixture of more than one solid substance.

18. The compound according to claim 1, wherein a ratio of [Part A plus Part B]:Part C is in the range of from about 1:1,000,0000 to about 10,000:1.

19. A method of using the compound according to claim 1, wherein the compound is applied to a medium selected from the group consisting of soil, water, living organism and artificial medium.

20. The method according to claim 19, wherein the quantity of said applied compound is in the range of about 0.0000001% to 99.99999% of a quantity of said medium.
